(19) United States
(12) Patent Application Publication
(10) Pub. No.: US 2008/0189735 A1
(43) Pub. Date: Aug. 7, 2008

(54) System and Method for Combining Media Data

(76) Inventors: Jason Shawn Barton, Chesapeake, VA (US); James David Barton, Suffolk, VA (US)

Correspondence Address: DUNCAN G. BYERS PC, 142 W. York Street, Suite 910, NORFOLK, VA, 23510, US

(21) Appl. No.: 11/964,700

(22) Filed: Dec. 26, 2007

Related U.S. Application Data
(60) Provisional application No. 60/871,878, filed on Dec. 26, 2006.

(51) Int. Cl. H04N 7/10

(52) U.S. Cl. 725/32

(57) ABSTRACT

System and method for processing media data set and transmission of the same in a data communication medium. A first set of data is scanned for specific time-indicating markers. A second set of data comprising one or more sub-sets of data are selected according to a predetermined set of criteria, and the second one or more sub-sets of data are inserted into the first set of data at the identified time-indicating markers located in the first data set. The method further comprises converting the data sets to formats suitable for viewing by a consumer. The new, combined data set is transmitted to the consumer.

This application claims the benefit of U.S. patent application Ser. No. 60/871,878 entitled “System and Method for Combining Media Data,” filed on Dec. 26, 2006.

### FIELD OF THE INVENTION

The present invention relates in general to electronic file distribution, and more particularly to systems and methods for capturing and converting existing media files into formats for storage and playback that are compatible with end consumer media playback devices, such as portable or desktop computers, portable media (i.e., music, video, etc.) playback devices, cellular telephones and the like. The present invention further relates to means to utilize existing advertising markers and gaps in media files to combine existing media content with advertising that is specifically targeted to the end consumer, either through matching advertising material to the media file content or by consumer profiles.

### BACKGROUND OF THE INVENTION

Electronic media, including movies and the like, reside in numerous formats. There is a demand for such media, whether newer blockbuster films, older classic films, family favorite television series, how-to programming, educational programming, or other media. Currently, there are large reserves of such media but most media is available, if at all, with fixed content that may or may not include advertising and, if it does, such advertising is often either out of date, not appropriate for or targeted correctly to the consumer, or both. When a movie or other program is provided in a digital format, such as on DVD (Digital Video Disc) either bought or rented by the consumer, or downloaded from the internet or other service, the content is unchangeable and has generally been fixed at some point in time prior to the media being ordered by the consumer and includes advertising content that quickly becomes outdated. The same is true of movie trailers attached to most movies provided to consumers; the trailers become quickly outdated and there is consequently a need to be able to update the trailers for new theater and DVD releases.

The fast-paced expansion of the movie industry, coupled with the explosion of broadband communications had fueled the need for large media files provided on demand, such as full length movies, video, television, etc. Broadband technology allows streaming and packeted data to be sent to an end user. The new technologies have allowed end consumers to become increasingly proactive in their search for media and as a result many consumers are demanding and utilizing greater personal control over the form and content of media. Further, on-demand delivery of media is becoming more popular with a consumer base that wishes to have control over when and how they view programming. The combination of broadband technology as well as the increase in the number and sophistication of the devices available to the consumer for media playback has also opened up new opportunities for users to receive movies, television shows and other media that are out of print, dated, or otherwise unavailable. There are numerous barriers to providing a consumer with such older media, however.

First, there is the inherent problem of converting older media to newer formats. Either the consumer or the provider must acquire the media (say in the form of VHS), and then convert the media, or rely upon the media provider to convert the media to an appropriate format. For the consumer, this requires a significant investment of both time and money. The consumer will generally have to own or have access to the necessary hardware (such as a VHS player with an output to a device that can convert the media—usually a computer with expensive conversion software). Such consumer conversion of media from data that is already copied and may be some generations removed from a master media data set results in significant degradation of the quality of the end product, as well as a large investment of time and money by a consumer who is ultimately only interested in procuring what is a relatively cheap bit of media programming.

For the media provider, converting the media on demand for the consumer (and in multiple formats) will consume large amounts of time and money that may or may not be offset by the profits made. This is truer the older the media source; as demand for such older media decreases, the cost of providing such media quickly outweighs the profits, especially as the market value of older programming decreases with time.

The costs of providing media that, in and of itself, does not generate significant (if any) revenues are traditionally offset by advertising revenue. Free television programming depends upon commercial revenue to pay the costs of creating and delivering media. Advertising, however, is changing even more rapidly than the underlying programming. On demand media delivery takes the programming control and ability to match advertising to the media and/or the consumer out of the hands of the media provider. Further, older media with fixed advertising cannot create a revenue stream based upon the advertising content because the advertising content is outdated. It is therefore generally not cost effective for the copyright owners of older media to rerun the older media (with the rare exception of some classic favorite films and the like) outside of traditional programming methods, such as television, where the media provider can replace older advertising with new advertising, thus offsetting the cost of providing the media. As a result, the needs of the consumer remain unmet while uncountable hours of entertainment, educational and other media sit unused and no longer earning revenue.

Meanwhile, the global marketplace for streaming and on-demand advertising has allowed advertisers to reach end users who would not otherwise be exposed to their advertising. In return, the end consumer has access to information and programming that they would otherwise not be able to access. But, without advertising revenues to defray the costs of providing media, a significant amount of media will never reach an audience, even though there may be demand for the media.

However, there is no current method by which end users can order and receive movies or other media that is streamed directly to them, and where the media is also updated with current advertising, or where the provided media is keyed specifically to the genre of the media and/or the particular needs and history of the consumer.

What is needed, therefore, is a method for the transfer of media to a consumer, whether the media is movies, television shows or the like with current and updated advertising material inserted into the primary media content. The present invention meets this need, and may be used equally effectively for new media as well as older media in order to keep the advertising content current as well as provide more efficient marketing through the specific targeting of the end consumer, either through matching advertising to the downloaded media content or by matching to a consumer profile. The present invention further provides for an economical system for updating advertising content in media that is delivered via traditional means such as VHS tape, DVD, CD and the like. Such advertising includes not only in program advertising, but other advertising (such as the previously mentioned movie trailers). By updating the advertising content in this manner, older media may be re-released to the public quickly and economically with updated advertising content.

### SUMMARY OF THE PRESENT INVENTION

The present method has far reaching application in the entertainment space where ads (a.k.a. commercials) need to be incorporated into video segments. Typically, ads are inserted into the video segments by either embedding the commercial(s) directly into the video, or by using a playlist method such as Synchronized Multimedia Integration Language (SMIL). The disadvantage of embedding the commercial directly into the video is that the ads are fixed to the media and therefore become outdated. The ad can never be replaced once disseminated to the consumer. In addition, the ads have a broad-brush effect, which may not be applicable to all viewers. This makes it very difficult to target ads to specific consumer interests. The process is further complicated by the touching and retouching of content. In order to update the ads within the video, the video must be edited and re-published with new ads, which will again become out-dated and suffer the same life cycle. This approach limits the provider's ability to leverage related products. The second method commonly used leverages SMIL to basically create a playlist that starts and stops video at the indicated time to run the commercials. This method suffers the same disadvantages as the direct embedding method, except the video does not have to be altered in order to update the ads. In contrast, the present invention leverages an ad service to determine the relevant ads based on intelligence gathering related to the consumer and/or the media and dynamically inserts commercials/ads at the appropriate ad insertion point based on time codes associated with a particular content segment. The content segment and the ads are then stitched together and delivered to the consumer. This process is much more dynamic than previously mention methods because ads can be stitched on the fly with chunks of video enabling the system to use specific ads targeting that specific consumer at the specific time of request and delivery. Each time the consumer device is synchronized to the system (which is transparent to them), existing ads can be replaced with new ones increasing the visibility of relevant products and services while giving the video a fresh feel.

In addition to providing the content provider with a means to redistribute older media content (and thus generate new revenue), the present invention also has applications outside of the entertainment industry. For example, surveillance and intelligence users (e.g., Department of Defense (DoD), Federal Emergency Management Agency (FEMA), Police, etc.) will find this process invaluable when capturing and archiving video from sensors (e.g., cameras, unmanned aerial vehicles, robots, unmanned ground vehicles, etc.) to disseminate to users in the field with limited bandwidth (e.g., mobile phones, PDAs, laptop). The video format that the consumer receives is heavily dependent on their device, bandwidth, and other consideration that must be determined during the transcoding process. Typically, video is transcoded using a “lossy compression” codec to produce the desired format (e.g., MPEG-2, DVD Quality). The advantage of using lossy compression is the heavy compression it allows enabling file sizes to be drastically reduced and thus made more manageable to the consumer during downloads. The disadvantage of this method is the loss of data and video quality, which can never be recovered from the original output.

Utilizing current methods to compress video, some data must be “lost” (from which it gets its name, lossy compression). To further complicate the problem the video may be re-transcoded into additional formats required to play on a given device. Each time the video is transcoded the picture quality continues to degrade. By leveraging a lossless compression method when capturing the video, the present invention retains near picture perfect quality without losing crucial data, while still being able to take advantage of lossy compression later when transcoding into the desired formats for dissemination. In addition, “chunking” the content as described herein provides multiple advantages such as security and performance. Military and entertainment industry alike have stringent security requirements which, by any other method, drastically hamper performance. Chunking the media content by utilizing the present invention enables the content to be properly labeled and encrypted ensuring the right user gets the right content as quickly as possible.

In sum, the present invention utilizes creating a master digital video file using a “lossless compression” format. This format enables video data to retain near perfect picture quality before transcoding in appropriate formats and chunking video into manageable chunks, which are extremely important methods for any application where video needs to be captured, converted and delivered to the consumer. This method further allows the stitching of advertising content into video delivered to an end consumer.

### BRIEF DESCRIPTION OF THE DRAWINGS

FIG. 1 shows an example of a High Level Video Service Process in accordance with one embodiment of the present invention.

FIG. 2 shows an example of the consumer download process wherein the consumer receives stitched together content containing both non-advertising and advertising media in accordance with one embodiment of the present invention.

FIG. 3 shows an example of the Stitching Process wherein advertising media is inserted into non-advertising media so that the completed media file, including advertising content, may be delivered via download or other means to the consumer in accordance with one embodiment of the present invention.

### DESCRIPTION OF A PREFERRED EMBODIMENT

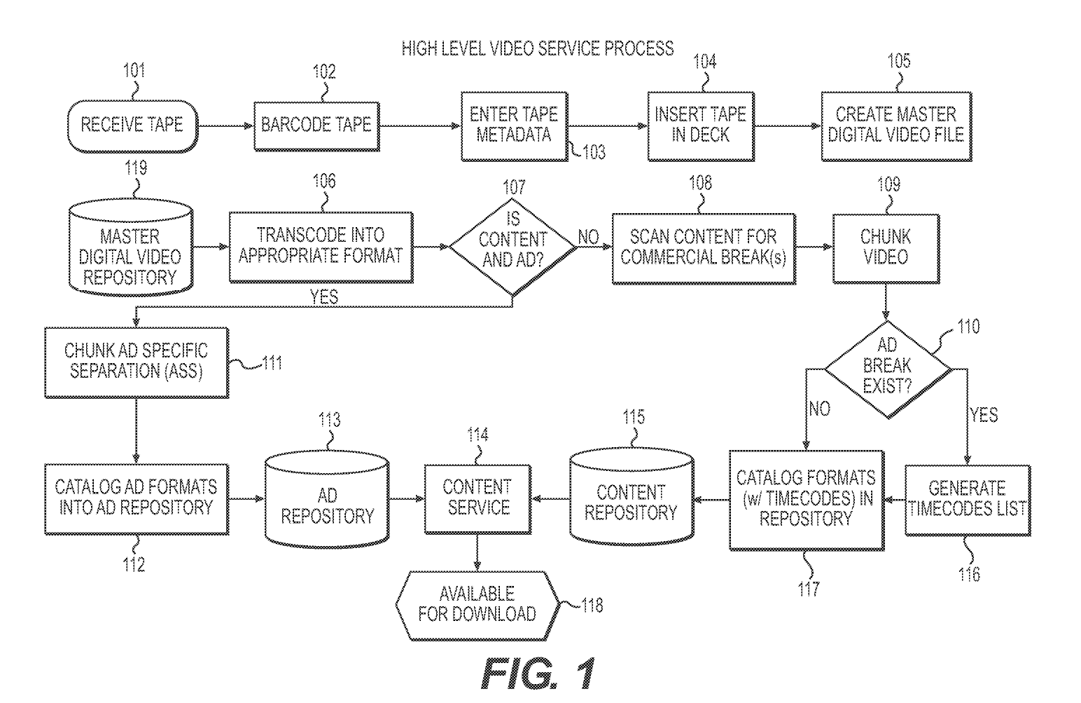

1. High Level Service Process (FIG. 1).

Referring now to FIG. 1, a media file is received 101 in the format and media in which it is currently stored and inventoried so that the original hard copy of the media may be retained in a safe manner, but also in such a manner so as to allow the content to be retrieved easily either for return to the source or for re-recording of the original content. The format that the material is received in may include digital video and audio as well as older movie formats, which may be stored on reel to reel tapes, VHS format tapes, Betamax® format tapes, and the like. The media file is assigned a unique identification barcode number 102 that will then be used to track the original data source (be it Digital Versatile Disc (DVD), VHS tape, etc.) as well as the content that has been processed for advertising insertion and distribution as described below. A barcode containing the unique identifying number is physically attached to the media containing the original data.

A. Metadata Set Generation.

Once a unique barcode number is assigned to the media, the barcode is scanned into the central archive system, which in turn keys a subroutine opening a Metadata Input Window (the “MIW”) in the archiving system. The MIW consists of sub-menus and text entry fields for logging the metadata and the subsequent metadata information data file. The metadata set is entered 103, and includes information keyed to the content of the media, such as title, author, genre or subject matter, running time, year of production, number or episode in a series, the primary and secondary subject matter(s) of the media, the talent and/or actors/actresses, producer, director, etc., and may include any other information related to the media that will assist in classification and identification of the media. The metadata set is archived in a searchable database that allows the metadata for all media entered into the system to be searched for key words and phrases related to the genre, title, actors and actresses, producer, etc. as well as such other data as the primary and secondary subject matter(s) of the media.

All media content received is divided into two primary categories: advertising media and non-advertising media. Each received and recorded type of media is categorized first into either of these two categories in the metadata set. The metadata set may further comprise identification of the content type of the media, such as educational, entertainment, how-to, etc., along with even further sub categories. For example, the how-to category may have sub categories such as home improvement, gardening, auto repair, etc., each of which may also be sub-categorized. The content of the media is the underlying programming that is non-advertising; i.e., the primary content that a consumer is interested in purchasing and viewing be it a television show, movie, or the like.

The primary and sub categories can be almost limitless, but are intended to provide two distinct advantages to the current method over existing methods. First, the categorization is geared specifically to the end user to allow the purchaser to narrowly define and find media that may be difficult if not impossible to find by other means. Secondly, the categorization method allows for the grouping of media by types so that advertising content may be specifically targeted to the end user, either by the type of media that is being requested by the purchaser and/or by the purchase or review history of a specific end user or group of end users.

B. Conversion Protocol and Master File Generation/Storage.

Once the metadata set for the media has been generated and stored, the media is identified for the proper conversion protocol. At this point, appropriate video conversion formats are chosen based upon a desired end user media player. For example, a portable video viewer may require the media be converted to 320×240 pixels, 30 frames per second (fps), MPEG-4 Part 10; a standard television will generally require 640×480 pixels, 30 fps, MPEG-4 Part 10; and a mobile telephone (i.e, a cellular telephone) may require the video be 160×120 pixels, 15 fps, MPEG-4 Part 2. As more mobile and stationary devices are developed and media protocols advance, the conversion formats will be changed to keep pace with the requirements of new technology.

The master media (i.e., VHS tape, DVD, CD, or the like) is inserted 104 into the capture system; i.e., generally inserting the master media into a compatible deck to read the media. The system captures the video from the master media, and creates a master digital file in JPEG2000 format 105. Other formats may be utilized now (or developed in the future), but the JPEG2000 format provides advantages over other current formats for a master file. For example, every frame is a ‘perfect picture’ (i.e, contains all information with no repeated and unchanged data from the previous frame deleted for compression purposes, providing a “lossless” format) which allows the frame rate, compression, key frame and other properties to be controlled to produce the best quality video for each media platform or device. The master file in lossless JPEG2000 format is archived in the Master Digital Video Repository 119. The master video file may then be transcoded 106 into desired video formats simultaneously, and tagged to metadata input captured for the video content. The transcoding occurs for all master media files, whether advertising content or other content.

2. Ad Specific Separation Chunking.

The captured non-advertising master media content is now processed for combination with the advertising media content.

The master media content is identified 107 as either advertising or non-advertising media. If the content captured from the master video file is non-advertising content, the content is scanned 108 for commercial breaks. This step may be performed prior to transcoding the content into various video formats, or may be performed after the conversion occurs. By scanning for commercial breaks prior to transcoding the content, however, the system establishes a one-step process which provides a more efficient method for separation or “chunking” of the video content. The video content is marked or tagged at the advertising/commercial breaks for “chunking” into subsets at the advertising breakpoints, with the breakpoints identified 110 as occurring just past the time point detected for ad insertion. Based upon those identified break points, the media is separated or “chunked” 109 into data subsets that begin and/or end at the advertising commercial breaks in the video file. This chunking 109 occurs for all sub-formats transcoded from the master media file.

If the content is identified 107 as advertising content, the same procedure as described above is applied to advertising media (e.g., commercials, etc.) that has been received from a source where there are multiple advertising videos or other media combined into a single data file. The breaks in the file are identified in the same manner as for the master media content, and the data file is chunked 111 into multiple, discreet advertising media files. This process separates multiple ads that have been captured or received from one media source where advertising content is combined with other content, be it advertising or programming, such as a VHS tape or the like into multiple, discreet media files, thus creating individual ads from a media source of many (or, as noted, from a source where advertising is mixed with other media).

The chunked 111 ad content is cataloged 112. Ads are then moved for storage into the Ad Repository 112. The chunked commercials and/or ads are coded to the metadata entered for the advertising content so that the advertising content may then be matched to the appropriate non-advertising media and/or the profile of a specific customer.

Based upon the scanned breaks in the media (both the advertising and non-advertising media), a timecodes list is generated 116 for each media file. The timecode list may be generated prior to chunking, simultaneously with the identification of the advertising breaks in the media. For advertising media that has been chunked, the timecode list generated identifies the time lengths of the advertising media, which allows the advertising media to be matched to the time breaks in the non-advertising media, and inserted as described below either singly or in groups that closely match the time breaks in the non-advertising media. Chunked non-advertising media content and the timecode list are cataloged 117 in the Content Repository 115, which serves as permanent hard storage for all of the non-advertising media. If no advertising breaks exist, the media content is cataloged 117 without generating a time code list for ad breaks (where there are no ad breaks in the media, there are no time codes for advertising breaks in the media). From the Content Repository 115 and the Ad Repository 113, both types of media content are made available for download 118 from the content service 1 14.

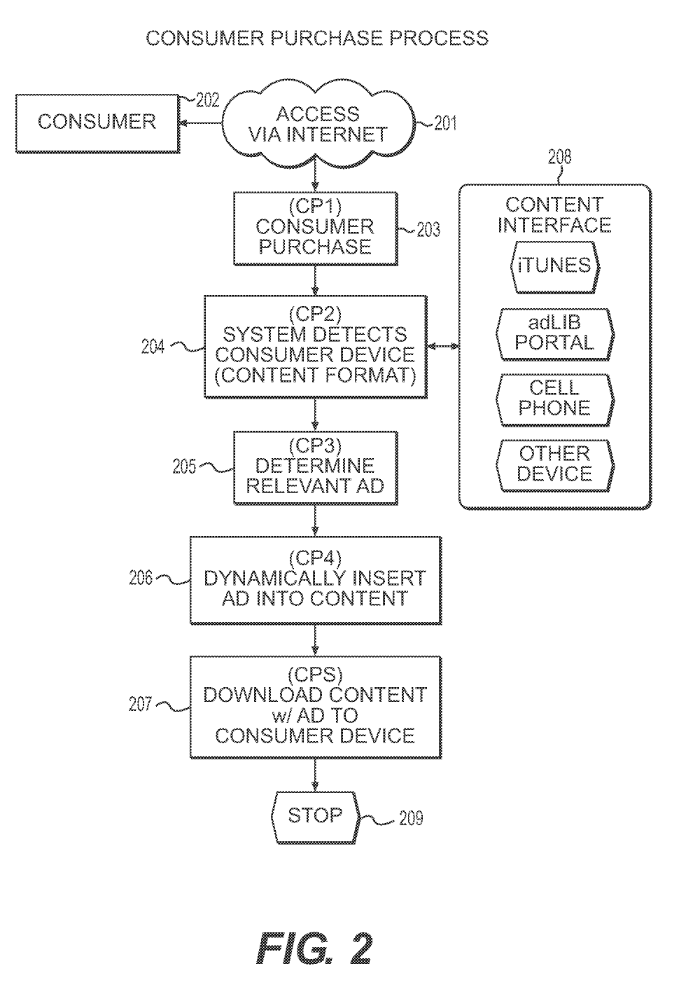

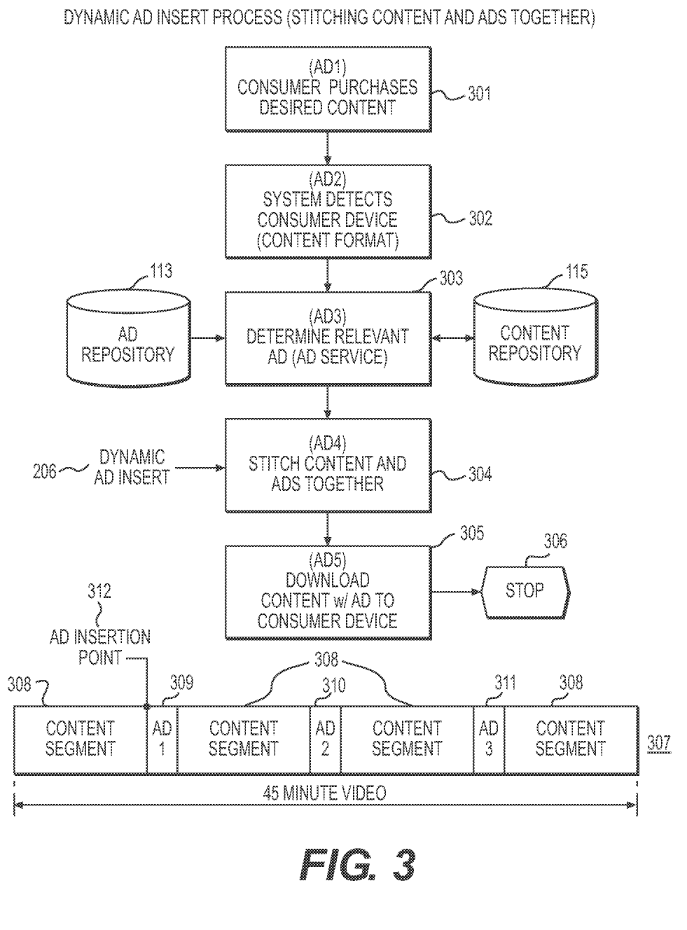

3. Consumer Purchase Process (FIG. 2) and Dynamic Ad Insertion Process (FIG. 3).

Referring now to FIGS. 2 and 3, a consumer 202 selects the desired media content through the consumer purchase process 203. Generally, such selection is made via internet access 201, although other access portals may be provided, and the desired media content may comprise video (such as video content provided in the entertainment industry or other media). The selected media may be provided free of charge to the end consumer, with the cost supported purely by advertising revenue from the advertising source. Such media could be of the “infomercial” type wherein the service provider would be paid for providing distribution services of that particular media. In the alternative, the end consumer could pay for the media download. Or, some alternative revenue generation may be provided for, such as sponsored programming and the like.

Once the consumer 202 has determined what media they would like to receive, the system detects 204 the consumer's device type that the purchased content will be downloaded onto and/or on which the media content will be viewed. The content interface 208 will be device specific; for example, the consumer may be viewing the received media content on a mobile phone, a portable video viewing device, a computer (e.g., desktop or laptop personal computer, etc.), download for “burning” onto another storage medium, such as DVD or CD, or a set-top-box that provides the content to a television and the content interface 208 will match the protocols for such interfaces as iTunes®, AdLib™ portals, cell phone protocols, or other device protocols.

Once the proper media format has been selected based upon the content interface 208, the system determines relevant ads 205 that match the content. The system determines relevant ads 205 based on either or both of two data sets. The first data set identifies the genre of content, referenced from the metadata for the media. For example, media such as home improvement may be matched with the same genre of advertising, such as tool manufacturers, retailers, or home repair supply advertising. The second data set used to determine relevant ads for insertion into the non-advertising media comprises established consumer profiles. The consumer profile data is collected either through multiple downloads by the same consumer or by the consumer creating an account with personal preferences. The consumer profile data is preferentially mined for interests that match advertising content, using a search engine similar to that or the same as the search engine that mines information from the metadata set for matching the non-advertising media to the appropriate advertising media.

With the advertising and media content chunks identified, the system inserts 206 the advertising into the content via the stitching service 304. After the advertising material is stitched into the content, the content is downloaded 207 with the inserted advertising content to the consumer device, and the process stops 209.

In one embodiment of the present invention, this method has application in the entertainment industry where a consumer may select video for purchase 203 from a variety of devices (e.g., iTunes, portal, phone, other device) from which the system will identify the consumer's device 204 in order to provide the appropriate video format. In addition, the system will have to determine the relevant advertising 205 that might be interesting to the consumer. This may be determined based on profile, purchase history, and (as the system grows more intelligent) purchase history from other consumers with similar interests. This is an important process that can stimulate consumer interest in other products and provide visibility while educating the customer on techniques, options and products, which may have normally been overlooked. The system will dynamically insert these ads 206 on the fly (i.e., as the request and download occur), and deliver the content to the consumer transparently, without direct interaction by the consumer. In yet another embodiment, the system can update advertising content each time a consumer device is synchronized with the system, allowing an avenue whereby content and ads that may have been shelved due to age or inability to update advertising to generate revenue for the content provider are being made available and utilized based on consumer demand.

Referring now to FIG. 3, the Dynamic Ad Insert Process is shown wherein the advertising content and the media content are stitched together for deliver as a complete media data file to the end consumer. As discussed above and shown in FIGS. 1 and 2, a consumer purchases 301 desired content, and the system detects 302 the consumer device so that the proper interface protocols may be utilized for downloading the content to the consumer device. As before, once the advertising and non-advertising media is stitched together 304, the content with the inserted advertising is downloaded 305 to the consumer device, and the process stops 306.

In order to stitch the content and the advertising together 304, the system calculates total length of time of the complete media content by adding timecodes for the content segments 308 and advertising content 309,310, and 311. The system then creates a Header based on the total time for the content plus ads and allows the video header to be written, which allows the end user to view the media file before the media is delivered in its entirety.

Once the time codes are added to the media content and the Header is created by the system, the advertising material is inserted into appropriately sized time slots in the media between the content chunks of the non-advertising media. For example, the final deliverable content may comprise a 45-minute video segment 307. In that segment 307 is shown content segments 308 and advertising content 309, 310, and 311. The content segments 309 are separated by the advertising content 309, 310 and 311, which are inserted into the final video segment 307 at the identified advertising insertion points 312. In the video segment 307 shown, there are three advertising segments 309, 310 and 311, separating the content into four segments 308. It will be understood that the number and advertising segments and content segments will vary, and each may comprise one or more. The header is downloaded to the consumer device first, and then the stitched content begins downloading, keyed to the header. The final content may be delivered via various means to the consumer. Online media downloads through internet connections may be used, while the content may also be delivered in hard media format such as DVD, CD, or other hard storage means.

Insofar as the description above and the accompanying drawings disclose any additional subject matter that is not within the scope of the single claim below, the inventions are not dedicated to the public and the right to file one or more applications to claim such additional inventions is reserved.

What is claimed is:

1. A method for editing data, comprising the steps of:
receiving a first data set;
assigning the said first data set a unique identification number;
entering said unique identification number in a central archiving system;
creating a metadata set associated with said unique identification number;
categorizing said metadata set as either content or non-content data;
further categorizing said metadata set further into one or more pre-determined content categories;
choosing one or more conversion protocols specific to desired types of consumer data;
inserting master media into a capture system;
capturing a second data set from said master media and converting said second data set into a master data set of predetermined format;
archiving said master data set in a master repository;
scanning said master data set for advertising breaks;
encoding said master data set with one or more tags at the said advertising breaks identified in the said master data set wherein said one or more tags identify the time location of said advertising breaks;
generating a time code list of the said advertising breaks in said master data set;
transcoding said master data set into said consumer data utilizing said one or more conversion protocols;
separating said master data set into sub-data sets at the said time locations;
storing said sub-data sets into a data repository;
receiving a consumer request for said master data set;
providing said master data set in the said sub-data set format; and
creating a consumer data set by inserting said first data set between said sub-data sets of said master data set.

2. The method of claim 1 wherein said first data set comprises advertising media.

3. The method of claim 1 wherein said second data set comprises media chosen from the group comprising television programming, movie content, or the like.

4. The method of claim 1 wherein said consumer data set is transmitted to a consumer playback device.

5. The method of claim 1 wherein said consumer data set is transmitted to a consumer recording device.

6. The method of claim 5 wherein said consumer recording device is a portable consumer recording and playback device.

7. The method of claim 1 wherein said master data set is converted to a lossless format.

8. The method of claim 7 wherein said lossless format is JPEG2000.

9. The method of claim 1 wherein said master media is chosen from the group comprising VHS format tape, DVD, CD, and the like.

10. The method of claim 1 wherein said advertising media is movie trailers and the like.

11. The method of claim 1 wherein said edited data content with inserted advertising media is made available for consumer download.

12. The method of claim 1 wherein said master media comprises television programming.

13. The method of claim 1 wherein said consumer data set comprises video capture data.

14. The method of claim 1 wherein inserted advertising content is chosen based upon a predetermined set of criteria.

15. The method of claim 14 wherein said predetermined set of criteria is collected based upon consumer preferences.

16. The method of claim 14 wherein said predetermined set of criteria is determined based upon metadata collected from said master media.

17. The method of claim 16 wherein said metadata collected from said master media identifies content criteria of said master media.

18. A method for editing data, comprising the steps of:
receiving a first data set;
assigning the said first data set a unique identification number;
entering said unique identification number in a central archiving system;
creating a metadata set from said unique identification number;
categorizing said metadata set as either content or non-content data;
further categorizing said metadata set further into pre-determined content categories;
choosing one or more conversion protocols specific to desired types of consumer data;
receiving master media in a capture system and capturing a second data set from said master media and converting said second data set into a master data set of predetermined format;
archiving said master data set in a master repository;
scanning said master data set for time code breaks;
encoding said master data set with one or more tags at the said time code breaks identified in the said master data set wherein said one or more tags identify the time location of said time code breaks;
generating a time code list of the said time code breaks in said master data set;
transcoding said master data set into said consumer data utilizing said one or more conversion protocols;
separating said master data set into sub-data sets at the said time locations;
storing said sub-data sets into a data repository;
receiving a consumer request for said master data set;
providing said master data set in the said sub-data set format; and
creating a consumer data set by inserting advertising media between transmitted said sub-data sets of said master data set.

19. The method of claim 18 wherein said master media comprises digital video data received electronically.

20. A system for editing data content, said system comprising:
means for receiving a first data set and converting said first data set into a lossless format;
means for creating a first metadata set;
means for associating said first metadata set with a unique identification number;
means for categorizing said first metadata set based upon predetermined content categories;
means for synchronizing with and identifying a consumer playback device and choosing a media conversion protocol compatible with said consumer playback device;
means for receiving a second data set;
means for converting said second data set into a lossless format master data set;
means for identifying time code breaks in said master data set;
means for encoding said master data set with tags wherein said tags identify the time location of said time code breaks;
means for generating a time code list of the said tags in said master data set;
means for transcoding said master data set into a media protocol compatible with an end user device;
means for separating said master data set into sub-data sets at said time code breaks;
means for receiving a consumer request for said master data set;
means for providing said master data set to a consumer via electronic transfer; and
means for creating a consumer data set by inserting said first data set into said master data set.

21. The system of claim 20 wherein said system further comprises means for electronically delivering to a consumer said consumer data set comprising said master data set with said first data set inserted into said master data set.
